(19) United States
(12) Patent Application Publication
(10) Pub. No.: US 2013/0252562 A1
(43) Pub. Date: Sep. 26, 2013

(54) HIGH POWER HIGH ISOLATION LOW CURRENT CMOS RF SWITCH

(71) Applicant: DSP Group, Ltd., Herzelia (IL)

(72) Inventors: Yaron Hasson, Elad (IL); Alex Mostov, Rishon Lezion (IL)

(73) Assignee: DSP Group, Ltd., Herzelia (IL)

(21) Appl. No.: 13/836,698

(22) Filed: Mar. 15, 2013

Related U.S. Application Data
(63) Continuation-in-part of application No. 13/823,367, filed on Jun. 5, 2013.

(51) Int. Cl. H04B 1/44

(52) U.S. Cl. CPC H04B 1/44
USPC 455/78

(57) ABSTRACT

A novel and useful RF switch that comprises four transistors configured to have four operating states, wherein at any time at most one transistor is in ‘on’ state. The switch is an on-chip switch and is constructed in using CMOS processes and technology. The switch is optionally a double pole, double throw (DPDT) switch. The switch can be used in numerous mobile devices such as a cellular phone or in the handset or base station of a cordless phone. The switch optionally selects between two antennas and between transmitter and receiver circuits. Within the switch, at least one of the at least four transistors is optionally an N-channel Metal Oxide Semiconductor (NMOS) transistor. The switch can further comprise one or more logic control circuits providing biasing voltages to one or more of the transistors. Within the switch, the control circuit comprises logic components for providing appropriate biasing voltages to the drain, source and gate terminals of the transistors in the switch.

### REFERENCE TO PRIORITY APPLICATION

This application claims priority to and is a continuation in part of U.S. Application Ser. No. 13/823,367, filed Mar. 14, 2013, entitled “RF Switch Implementation in CMOS Process,” which is based on PCT/IL2010/000787, filed Sep. 21, 2010, entitled “RF Switch Implementation in CMOS Process,” incorporated herein by reference in their entirety.

### FIELD OF THE INVENTION

The present invention relates to the field of electronic switching, and more particularly relates to a low current CMOS RF switch exhibiting high power capability and high isolation.

### BACKGROUND OF THE INVENTION

Consumer products such as communication devices and in particular wireless telephones have long become standard commodities. There are a large number of manufacturers of such devices, which leads to increased competition and price wars.

One of the factors that limit price reduction is the actual cost of the components making up the device, including resistors, capacitors, diodes, etc., which are external to the chip or chip-set that constitute the core of the device.

Placing such components on the device, however, is impossible due to the different technologies used. For example, PIN diodes cannot be placed on the chip to their unavailability in standard CMOS processes.

The components which are external to the chip or chip-set increase the cost of the device in a number of ways: (1) they must be manufactured or purchased; (2) their assembly within the device incurs resources including equipment and labor; and (3) they consume valuable printed circuit board (PCB) real estate, thus requiring larger printed circuit boards.

There is thus a need in the art for a communication device that can be manufactured at lower cost than traditional devices, and for a method for manufacturing the same, which would enable a cost reduction without sacrificing device capabilities.

### SUMMARY OF THE INVENTION

A novel and useful RF switch that comprises four transistors configured to have four operating states, wherein at any time at most one transistor is in ‘on’ state. The switch is an on-chip switch and is constructed in using CMOS processes and technology. The switch is optionally a double pole, double throw (DPDT) switch. The switch can be used in numerous mobile devices such as a cellular phone or in the handset or base station of a cordless phone. The switch optionally selects between two antennas and between transmitter and receiver circuits. Within the switch, at least one of the at least four transistors is optionally an N-channel Metal Oxide Semiconductor (NMOS) transistor. The switch can further comprise one or more control circuits providing biasing voltages to one or more of the transistors. Within the switch, the control circuit comprises logic components for providing appropriate biasing voltages to the drain, source and gate terminals of the transistors in the switch.

In another aspect of the disclosure a wireless communication device such as cordless phone system having a handset and a base station is disclosed. The base station comprises a first antenna and a second antenna, each of the first antenna and the second antenna being operative to transmit and receive data, and one or more switches for operating the first or second antenna, in a transmitting or receiving mode. The switch comprises four transistors, whereby a low pass filter is coupled between the drain, source and gate terminals of each transistor and the logic control circuit. Within the wireless communication device, the handset comprises a switch having four transistors, the switch located on a chip of the handset.

Integrating the RF switch in a mixed signal CMOS process simplifies the implementation of an antenna diversity design and therefore improves system performance. The low current consumption of the switch makes it particularly attractive for use in mobile devices. The reduced component count required by the switch is useful when implemented in hand held devices while simplifying application board design and integration and significantly reducing cost.

There is thus provided in accordance with the invention, a radio frequency (RF) switch, comprising a first transistor operative to couple a transmit signal from a transmitter to a first antenna, a second transistor operative to couple said transmit signal from a transmitter to a second antenna, a third transistor operative to couple a receive signal from said first antenna to a receiver, a fourth transistor operative to couple said receive signal from said second antenna to said receiver, and a control circuit coupled to said first transistor, said second transistor, said third transistor and said fourth transistor, said control circuit operative to place only one of said four transistors in an on state while placing the remaining three transistors in a reverse biased off state.

There is also provided in accordance with the invention, a radio frequency (RF) switch, comprising a first transistor having a source, drain and gate, said first transistor operative to couple a transmit signal from a transmitter to a first antenna, a second transistor having a source, drain and gate, said second transistor operative to couple said transmit signal from a transmitter to a second antenna, a third transistor having a source, drain and gate, said third transistor operative to couple a receive signal from said first antenna to a receiver, a fourth transistor having a source, drain and gate, said fourth transistor operative to couple said receive signal from said second antenna to said receiver, a control circuit coupled to the source, drain and gate terminals of said first transistor, said second transistor, said third transistor and said fourth transistor, said control circuit operative to generate source, drain and gate signals such that only one of said four transistors is in an on state while placing the remaining three transistors in a reverse bias off state.

There is further provided in accordance with the invention, a method for use with a radio frequency switch, said method comprising providing a first transistor having a source, drain and gate, said first transistor operative to couple a transmit signal from a transmitter to a first antenna, providing a second transistor having a source, drain and gate, said second transistor operative to couple said transmit signal from a transmitter to a second antenna, providing a third transistor having a source, drain and gate, said third transistor operative to couple a receive signal from said first antenna to a receiver, providing a fourth transistor having a source, drain and gate, said fourth transistor operative to couple said receive signal from said second antenna to said receiver, generating source, drain and gate signals for said first transistor, said second transistor, said third transistor and said fourth transistor, such that only one of said four transistors is in an on state while the remaining three transistors are in a reverse bias off state, wherein a transistor is placed in an on state by forward biasing its gate-source junction, and wherein a transistor is placed in an off state by reverse biasing its gate-source junction.

There is also provided in accordance with the invention, a wireless communication device, comprising a first antenna, a second antenna, a transmitter, a receiver, an RF switch; said RF switch comprising a first transistor operative to couple a transmit signal from said transmitter to said first antenna, a second transistor operative to couple said transmit signal from a transmitter to said second antenna, a third transistor operative to couple a receive signal from said first antenna to said receiver, a fourth transistor operative to couple said receive signal from said second antenna to said receiver, and a control circuit coupled to said first transistor, said second transistor, said third transistor and said fourth transistor, said control circuit operative to place only one of said four transistors in an on state while placing the remaining three transistors in a reverse biased off state.

### BRIEF DESCRIPTION OF THE DRAWINGS

The invention is herein described, by way of example only, with reference to the accompanying drawings, wherein:

FIG. 1 is a high level schematic diagram illustrating an example RF switch and related control circuit constructed in accordance with the present invention;

FIG. 2 is a schematic diagram illustrating an example RF switch and related control circuit in more detail;

FIG. 3 is a high level schematic diagram illustrating an example RF switch and matching circuitry constructed in accordance with the present invention; and

FIG. 4 is a high level block diagram illustrating an example wireless device incorporating the RF switch of the present invention.

### DETAILED DESCRIPTION OF THE INVENTION

The transmit/receive (T/R) switch is one of the building blocks typically part of the RF front end circuit of a radio. In addition, an antenna diversity function is known to improve system performance. In one embodiment, a double-pole, double-throw (DPDT) switch is used to couple the transmitter and receiver to either of two antennas.

In one embodiment, four PIN diodes are used to implement such a DPDT switch along with the appropriate peripheral components that are used for biasing and matching networks. Depending on the technology used for the integrated circuit (IC) transceiver circuitry, the PIN diodes are likely to be external to chip. In addition, to turn PIN diode switch on requires a forward biasing current in the order of 5 to 10 mA. The use of PIN diodes to implement an external DPDT switch, however, increases the bill of materials (BOM), printed circuit board size, board assembly complexity, etc.

In an alternative embodiment, gallium arsenide (GaAs) based switches are used to implement the RF switch. GaAs based switches provide good linearity and isolation with low on resistance and off capacitance. Disadvantages of GaAs, however, include (1) the requirement of negative gate voltage to turn off due to their N-channel depletion mode configuration; (2) driving GaAs switches typically requires additional interface components; and (3) the difficulty of integrating other functions such as logic control and memory on the same chip.

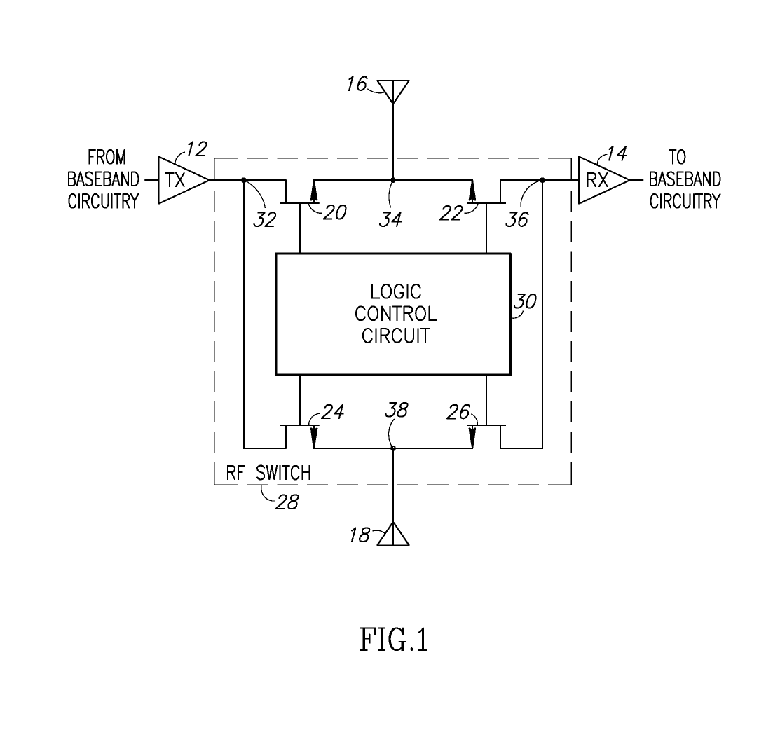

A high level schematic diagram illustrating an example RF switch and related control circuit constructed in accordance with the present invention is shown in FIG. 1. The switch circuit, generally referenced 10, comprises an RF switch coupled to a transmitter (TX) 12, receiver (RX) 14, a first antenna 1 16 and a second antenna 2 18. The RF switch 28 comprises four transistors 20, 22, 24, 26 coupled to and controlled by logic control circuit 30.

In one embodiment, the RF switch is implemented entirely in CMOS and exhibits, high power, low current and high isolation while enabling integration with logic control circuitry and other digital circuitry based functions. Such an RF switch may be incorporated into a wireless device such as a mobile phone, cordless phone, etc. described in more detail infra.

Consider a wireless device such as a cordless phone including a base and one or more handsets. The handset usually comprises a single antenna with the recent trend of manufacturers implementing antenna diversity in the handset. Due to relatively small physical dimensions of the hand-set, regular space diversity is not practical. Thus, cordless phone manufacturers implement polarization diversity in hand-sets where one of the antennas is vertically polarized while a second antenna is horizontally polarized. This can improve the performance of the link up to 6 dB, on top of approximately 10 dB statistical improvement of diversity antenna in the base. The integrated CMOS DPDT switch of the present invention has additional advantages in the case of antenna diversity in hand-sets (HS) including requiring less PCB area which is critical in HS design; easy integration; and low BOM. The base station may comprise one or two antennas placed at a spatial angle to each other. At each point in time, space diversity is achieved, e.g., an antenna for which the direct wave and the reflected wave create constructive interference rather than destructive interference.

The transmit/receive (T/R) 28 switch is a basic building block in many RF front end circuits. Such a switch is operative, for example, to determine whether a particular antenna will be used in a transmitting state or in receiving state.

To improve performance, the base station or handset of a mobile communication device such as a cordless phone requires two switches, one for selecting the preferred antenna, and the other for selecting the communication direction, i.e. transmission or reception.

In one embodiment, the T/R switch comprises a double pole, double throw (DPDT) switch that comprises two pairs of diodes plus peripheral components such as resistors, impedance matching components, etc. To reduce costs, the switches are placed on the same integrated circuit. PIN diodes, however, typically constructed from GaAs technology cannot be placed on the same integrated circuit with circuitry constructed using CMOS processes and technology.

In one embodiment, the T/R switch is implemented as an arrangement of four transistors. The T/R switch reduces the previous requirement of multiple components located external to the chip by integrating their functionality onto the chip. The switch is implemented in a CMOS process, and the associated networks are based on bond wires having high quality (Q) factor.

The RF switch incorporates four transistors which may comprise N-channel Metal Oxide Semiconductor (NMOS) transistors, for example. A logic control circuit 30 functions to control each individual transistor which is controlled independently of each other. The switch 28 comprises four ports including: (1) antenna 1 port; (2) antenna 2 port; (3) transit port; and (4) receive port. In addition, the switch can be in any one of four states including: (1) transmitting from antenna 1 by coupling TX 12 to antenna 1; (2) transmitting from antenna 2 by coupling the TX to antenna 2; (3) receiving from antenna 1 by coupling antenna 1 to RX 14; and (4) receiving from antenna 2 by coupling antenna 2 to the RX.

Thus, in any state, only one of the four transistors is in the ‘on’ state. The remaining three transistors of the switch are in the ‘off’ state. A transistor that is in the ‘on’ state has its gate-drain junction forwarded biased. For the switch to achieve relatively low insertion loss and high isolation, the other three transistors that are in the ‘off’ state have their gate-drain junctions reverse biased.

With reference to FIG. 1, the configuration shown enables the TX 12 output signal to be coupled to either antenna 1 or 2. It also enables either antenna 1 or antenna 2 to be coupled to the input of the RX 14. The switch comprises four transistors 20, 22, 24, 26 wherein each is controlled independently by logic control circuit 30 which turns each transistor on and off depending on the particular operating state. Thus, transistor 20 is ‘on’ or closed only if the switch is in transmit mode through antenna 1 (104) and is ‘off’ or open in all other states. Transistor 22 is ‘on’ or closed only if the switch is in transmit mode through antenna 2 and is ‘off’ or open in all other states. Transistor 24 is ‘on’ or closed only if the switch is in receive mode through antenna 1 and is ‘off’ or open in all other states. Transistor 26 is ‘on’ or closed only if the switch is in receive mode through antenna 2 and is ‘off’ or open in all other states.

This arrangement enables the construction of the switch in an integrated circuit, such that no special substrate (e.g., GaAs) is required and silicon with standard doping such as 10 ohm-cm can be used.

Note that the four transistor configuration of the RF switch functions to reduce the total equivalent parasitic capacitance of the three transistors that are in ‘off’ state when the fourth transistor is in ‘on’ state. In each switch state, all parasitic capacitances are in series and thus there is no need for an inductor or RF choke to reduce the total parasitic capacitance.

The ability of the RF switch circuit 28 to achieve relatively high isolation will now be described in more detail. Referring to FIG. 1, consider, for example, the operating state whereby the TX is connected to antenna 1. In this state the NMOS transistor 20 is in the ‘on’ state and the other three NMOS transistors are in the ‘off’ state. In this operating state, it is desired to maximize the isolation between the TX and antenna 2 and between the TX and RX. This is in order to keep the RF leakage from the TX to antenna 1 as low as possible.

There are two leakage paths between the TX and antenna 2: (1) via the ‘off’ C_{DS} of NMOS transistor 24; and (2) via the ‘off’ C_{DS} of NMOS transistor 22 at junction 32 which sees the LC matching circuit and turned off RX, and the ‘off’ C_{DS} of NMOS transistor 26. The above two leakage paths have different insertion loss vectors (in both amplitude and phase). These two leaky TX signals combine at junction 38 (i.e. antenna 2) and partially destructively interfere with each other, thereby increasing the isolation between antenna 1 and antenna 2. Note that similar consideration and operation applies for the isolation between TX and RX, and also for each of the other three DPDT operating states (i.e. TX to antenna 2, RX to antenna 1 and RX to antenna 2).

It is further noted that operating the RF switch in a manner as described supra (i.e. only one ‘on’ NMOS transistor and three ‘off’ transistors) with two leakage paths that destructively interfere with each other, enable the switch to exhibit high isolation and low insertion loss using standard CMOS processes without the requirement of on-chip (with large die area requirements) or off-chip dedicated inductors in resonance with the ‘off’ C_{Ds} capacitors of the NMOS switch transistors.

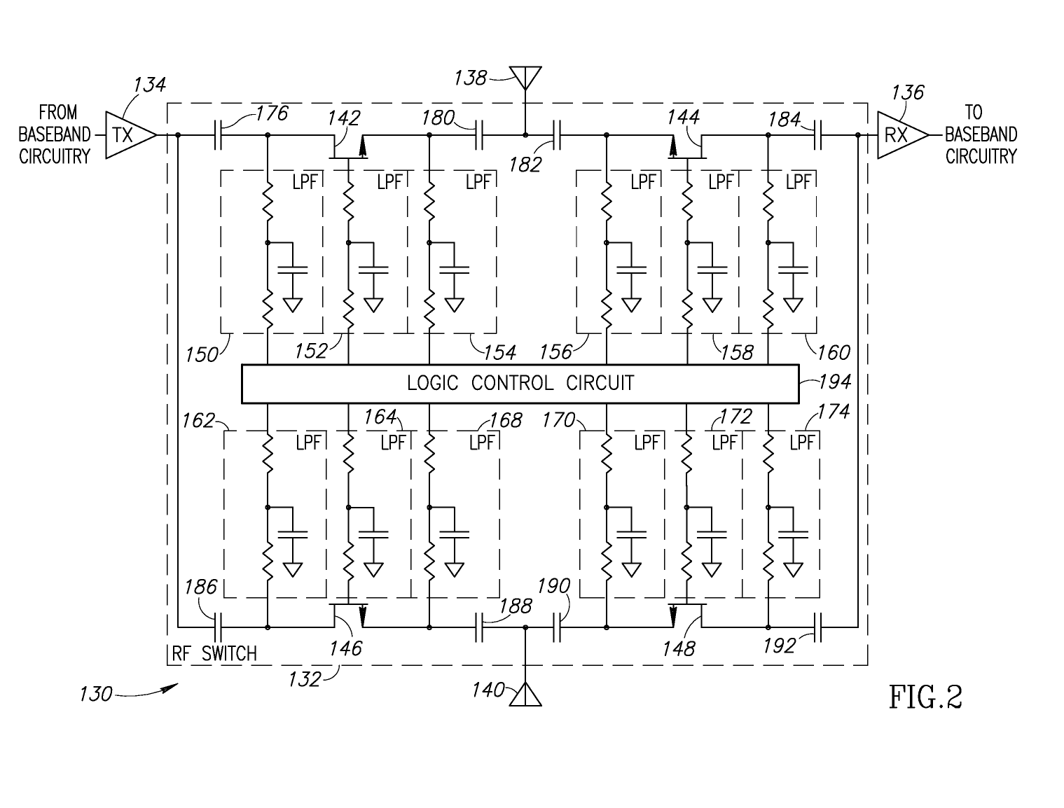

A more detailed description of the RF switch will now be provided with reference to FIG. 2. The RF switch circuit, generally referenced 130, comprises an RF switch 132 coupled to TX 134, RX 136, antenna 1 138 and antenna 2 140. The RF switch 132, comprises a first transistor 142, low pass filter (LPF) circuits 150, 152, 154 and dc blocking capacitors 176, 180; a second transistor 144, LPF circuits 156, 158, 160 and dc blocking capacitors 182, 184; a third transistor 146, LPF circuits 162, 164, 166 and dc blocking capacitors 186, 188; fourth transistor 148, LPF circuits 170, 172, 174 and dc blocking capacitors 190, 192 and logic control circuit 194. Each LPF circuit comprises a resistor 194, capacitor to ground 196 and resistor 196 connected in a PI configuration.

The logic control circuit functions to generate the biasing voltages for the drain, source and gate terminals of the four transistors. The biasing signals are applied through the low pass filter networks to the drain, source and gate of each transistor. The function of the LPF circuits is to suppress the RF leakage from the drain, source and gate of each transistor to the logic control circuit. In addition, the LPF circuits also function to increase the isolation between the one ‘on’ transistor and the three ‘off’ transistors. Note that other RC type filter networks can be used without departing from the scope of the invention as is known in the art. Note also that the use of the RC filter networks avoids the needs for RF chokes which is desirable when implementing the switch in CMOS circuitry. Alternatively, RF chokes may be used either external to the chip or integrated therein. Note further that for a signal to leak from one transistor terminal to another, the leakage path must pass through at least two filter networks.

Note that for the switch to operate at relatively high TX power levels (e.g., ≧25 dBm) and high VSWR, a deep N-well CMOS process is used to construct the N-channel FETs 142, 144, 146, 148. The blocking capacitors and low pass filters provide high isolation for each transistor from its neighbors notwithstanding the drain-source capacitance of the transistors. Moreover, the blocking capacitors 178, 180, 182, 184, 186, 188, 190, 192 function to allow the biasing of each NMOS transistor independently of the respective three neighboring transistors.

To place the switch in one of the four operating modes, one of the transistors is turned on while the remaining three are off. Note that an additional operating state may comprise all four transistors in the off state such as in a sleep or low power mode. To turn a transistor on, a relatively high voltage (e.g., 3.6V) is applied to the gate while the drain and source terminals are connected to ground. Thus, V_{GS} is 3.6V forward biasing the transistor. To turn a transistor off, a high voltage (e.g., 3.6V) is applied to the drain and source while the gate is connected to ground. Thus, V_{GS} is −3.6V reverse biasing the transistor. It is important to note that reverse biasing the transistors that are to be turned off in a particular operating state rather than connecting the gate, drain and source to ground (or controlling the gate terminal only and keeping drain and source biasing constant) enables the RF switch to achieve significantly higher isolation on the order of approximately 17 dB.

The low pass filter networks on the source, drain and gate terminals also function to provide termination so that the antenna has constant impedance relative to the ground. The primary purpose of the LPF is to suppress the RF leakage from the drain, gate and source to the logic control circuit, thus preventing RF signal loss in the logic control circuit. This is achieved by configuring the switch circuit such that the impedance of the NMOS transistor is determined only by the physical parameters of the NMOS transistor itself (e.g., R_{DS-ON}, C_{DS-OFF}, C_{G}, C_{D}, C_{S}) and is independent of the logic control circuit.

It is appreciated that the logic control circuit is exemplary only and other components can be used for enabling the transistors to function such that each is turned on and off with the correct timing and synchronization in accordance with the particular application. The transistors and all related components can be placed on-chip, thus reducing cost.

It will also be appreciated that the RC network for the low pass filters and other components associated with the transistors are an example and that other circuits that perform similar functions may be used as is known in the electrical arts.

The logic control circuit controls for each transistor its gate, drain and source. The configuration and use of CMOS technology provide for low current consumption on the order of microamperes, as well as high isolation and flexibility as compared to prior art switches.

Note that the disclosed RF switch can also be used in environments in which only one antenna is available, such as in handsets without antenna diversity. The reduced cost and size may justify such usage as opposed to the use of external PIN diodes even when the full functionality of the RF switch is not utilized. The RF switch is not limited for use to any type of device and can be used for any environment in which multiple switches are required, such as wireless local area network access points (WLAN AP), cellular phones, cordless phones, communication systems, radar systems or the like.

In an alternative embodiment, the RF switch configuration can be expanded to include additional transistors and control circuits for switching between additional ports, e.g., additional antenna, TX and RX ports. A switch matrix can be used, such as an N×M matrix of elements, wherein each element is implemented as a single NMOS transistor, an L series shunt combination, or a T or PI combination. Any of these combinations can be implemented as a complementary switch, comprising NMOS and PMOS. It will be appreciated that various modifications and variations can be designed. For example, different peripheral components and control circuits can be used.

As described supra, the DPDT switch comprises four external terminals (i.e. pins or ports): Antenna 1, Antenna 2, TX and RX. For each of the terminals (pins) there are one or more parallel and/or series bond wires that connect the external pins to the internal on die DPDT terminals (i.e. bonding pads). In one embodiment, the bond wires measure a nominal 0.7 mil in diameter and made of copper or gold. The bond wires function not only connect the internal circuitry on the semiconductor die to the external pins of the device package but also function tune out or offset the capacitance of the transistors. The one or more bond wires per pint exhibit a relatively high Q factor which contributes to a lower insertion loss for the connection. The particular die position and the number of parallel bond wires used is adapted so as to tune out the NMOS switch input capacitance, thus simplifying the external matching network and achieving a lower insertion loss for the switch. This is described in more detail infra.

In particular, the one or more bond wires coupling the external TX pin to the semiconductor die is operative to tune out the capacitance of the drains of NMOS transistors 142 and 146. The one or more bond wires coupling the external antenna 1 pin to the semiconductor die is operative to tune out the capacitance of the sources of NMOS transistors 142 and 144. The one or more bond wires coupling the external RX pin to the semiconductor die is operative to tune out the capacitance of the drains of NMOS transistors 144 and 148. The one or more bond wires coupling the external antenna 2 pin to the semiconductor die is operative to tune out the capacitance of the sources of NMOS transistors 146 and 148.

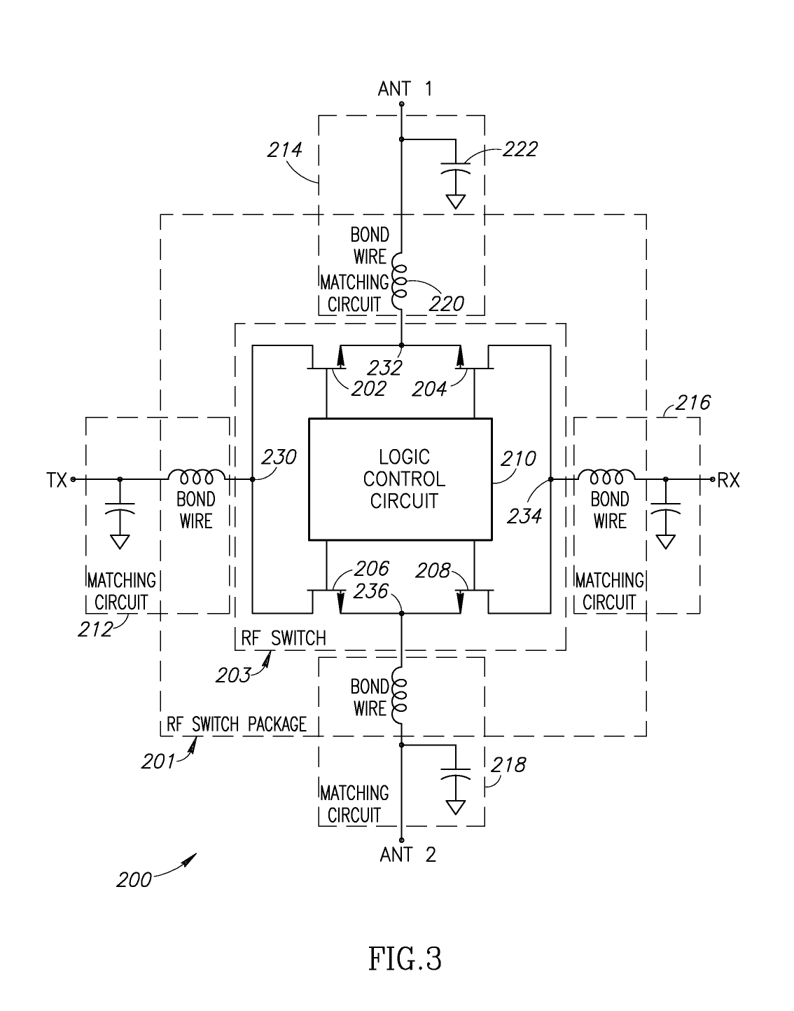

A high level schematic diagram illustrating an example RF switch and matching circuitry constructed in accordance with the present invention is shown in FIG. 3. The circuit, generally referenced 200, comprises a four port RF switch package 201 connected to a TX, RX, antenna 1 and antenna 2. The RF switch package 201 comprises an RF switch semiconductor die 203. The RF switch die 203 comprises logic control circuit 210 coupled to transistors 202, 204, 206, 208 which in the example embodiment shown are NMOS devices. The bonding pads of the die 202 are connected to the external chip pins via bonding wires 220. The combination of the bonding wire 220 and external PCB based shunt capacitor 222 form a matching network 214 disposed between the external TX, RX, antenna 1, antenna 2 and the respective four switching transistors.

The bond wires 220 and external shunt capacitor 222 form a matching circuit to each of the DPDT ports. At each of the four junctions 230, 232, 234, 236 the circuit sees either twice the drain capacitance (i.e. junctions 230, 234) or twice the source capacitance (i.e. junctions 232, 236). Due to the relatively large area of the NMOS devices (e.g., on the order of 1 mm wide), this capacitance is on the order of 0.5 to 1.5 pF. In order to tune out this capacitance as seen at the input ports, the inductance presented by the bond wire (one or more in parallel and/or series) in combination with the PCB copper traces is adapted to resonate and form a tuned circuit in the range of desired frequencies (e.g., DECT 1.8-2.0 GHz and the 2.4 GHz ISM band). The off-chip external parallel shunt capacitor 222 on the PCB functions, in combination with the inductance of the bond wires to present a matching 50 Ohms impedance to the TX, RX, antenna 1 and antenna 2 ports. Note that the bond wires are typically part of a package (e.g., quad, flat, no leads or QFN) having a diameter of 0.7 to 1 mils and constructed from gold, copper or aluminum.

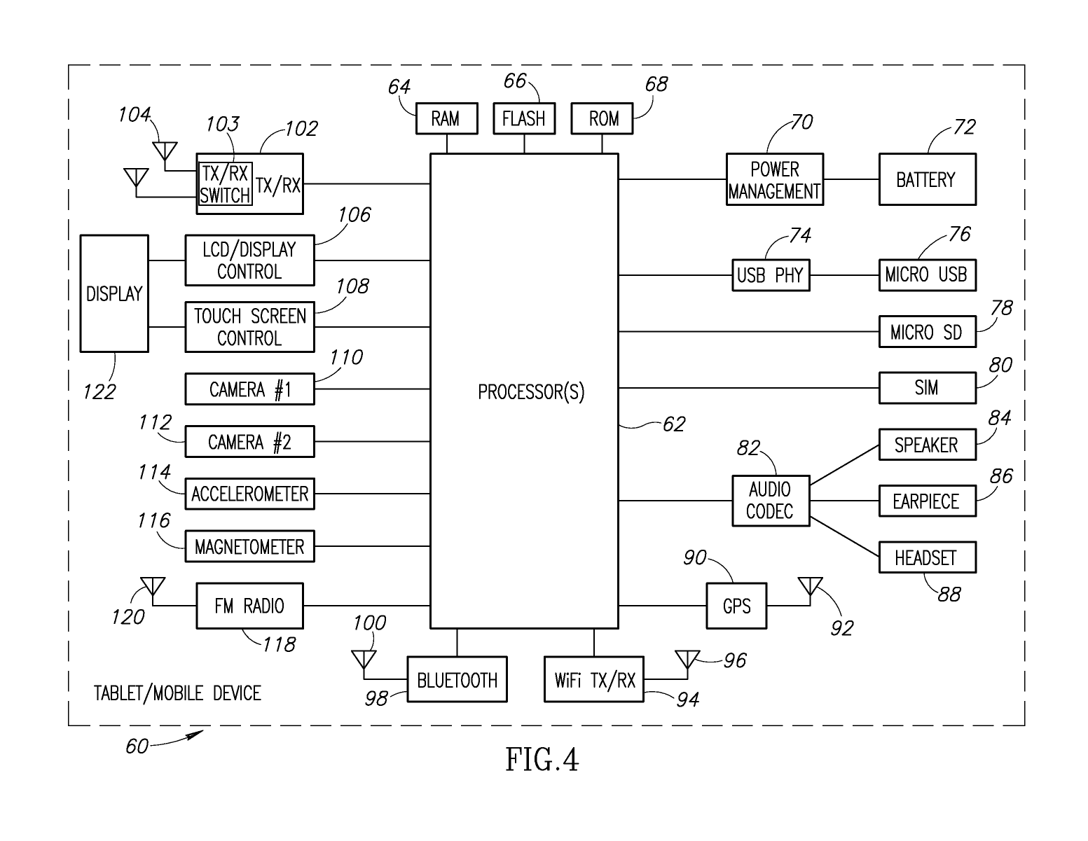

A high level block diagram illustrating an example wireless device incorporating the RF switch of the present invention is shown in FIG. 4. The mobile device is preferably a two-way communication device having voice and/or data communication capabilities. In addition, the device optionally has the capability to communicate with other computer systems via the Internet. Note that the mobile device may comprise any suitable wired or wireless device such as multimedia player, mobile communication device, cellular phone, cordless phone, smartphone, PDA, PNA, Bluetooth device, tablet computing device such as the iPad, etc. For illustration purposes only, the device is shown as a mobile device, such as a cellular based telephone, cordless phone, smartphone or superphone. Note that this example is not intended to limit the scope of the mechanism as the invention can be implemented in a wide variety of communication devices. It is further appreciated the mobile device shown is intentionally simplified to illustrate only certain components, as the mobile device may comprise other components and subsystems beyond those shown.

The mobile device, generally referenced 60, comprises one or more processors 62 which may comprise a baseband processor, CPU, microprocessor, DSP, etc., optionally having both analog and digital portions. The mobile device may comprise a plurality of radios 102 (e.g., cellular, cordless phone, etc.), TX/RX switch 103 constructed in accordance with the present invention and associated antennas 104. Radios for the wireless link and any number of other wireless standards and Radio Access Technologies (RATs) may be included. Examples include, but are not limited to, Digital Enhanced Cordless Telecommunications (DECT), Code Division Multiple Access (CDMA), Personal Communication Services (PCS), Global System for Mobile Communication (GSM)/GPRS/EDGE 3G; WCDMA; WiMAX for providing WiMAX wireless connectivity when within the range of a WiMAX wireless network; Bluetooth for providing Bluetooth wireless connectivity when within the range of a Bluetooth wireless network; WLAN for providing wireless connectivity when in a hot spot or within the range of an ad hoc, infrastructure or mesh based wireless LAN (WLAN) network; near field communications; UWB; GPS receiver for receiving GPS radio signals transmitted from one or more orbiting GPS satellites, FM transceiver provides the user the ability to listen to FM broadcasts as well as the ability to transmit audio over an unused FM station at low power, such as for playback over a car or home stereo system having an FM receiver, digital broadcast television, etc.

The mobile device may also comprise internal volatile storage 64 (e.g., RAM) and persistent storage 68 (e.g., ROM) and flash memory 66. Persistent storage 68 also stores applications executable by processor(s) 62 including the related data files used by those applications to allow device 60 to perform its intended functions. Several optional user-interface devices include trackball/thumbwheel which may comprise a depressible thumbwheel/trackball that is used for navigation, selection of menu choices and confirmation of action, keypad/keyboard such as arranged in QWERTY fashion for entering alphanumeric data and a numeric keypad for entering dialing digits and for other controls and inputs (the keyboard may also contain symbol, function and command keys such as a phone send/end key, a menu key and an escape key), headset 88, earpiece 86 and/or speaker 84, microphone(s) and associated audio codec or other multimedia codecs, vibrator for alerting a user, one or more cameras and related circuitry 110, 112, display(s) 122 and associated display controller 106 and touchscreen control 108. Serial ports include a micro USB port 76 and related USB PHY 74 and micro SD port 78. Other interface connections may include SPI, SDIO, PCI, USD, etc. for providing a serial link to a user's PC or other device. SIM/RUIM card 80 provides the interface to a user's SIM or RUIM card for storing user data such as address book entries, user identification, etc.

Portable power is provided by the battery 72 coupled to power management circuitry 70. External power is provided via USB power or an AC/DC adapter connected to the power management circuitry which is operative to manage the charging and discharging of the battery. In addition to a battery and AC/DC external power source, additional optional power sources each with its own power limitations, include: a speaker phone, DC/DC power source, and any bus powered power source (e.g., USB device in bus powered mode).

Operating system software executed by the processor 62 is preferably stored in persistent storage (i.e. ROM 68), or flash memory 66, but may be stored in other types of memory devices. In addition, system software, specific device applications, or parts thereof, may be temporarily loaded into volatile storage 64, such as random access memory (RAM). Communications signals received by the mobile device may also be stored in the RAM.

The processor 62, in addition to its operating system functions, enables execution of software applications on the device 60. A predetermined set of applications that control basic device operations, such as data and voice communications, may be installed during manufacture. Additional applications (or apps) may be downloaded from the Internet and installed in memory for execution on the processor. Alternatively, software may be downloaded via any other suitable protocol, such as SDIO, USB, network server, etc.

Other components of the mobile device include an accelerometer 114 for detecting motion and orientation of the device, magnetometer 116 for detecting the earth's magnetic field, FM radio 118 and antenna 120, Bluetooth radio 98 and antenna 100, Wi-Fi radio 94 including antenna 96 and GPS 90 and antenna 92.

In accordance with the invention, the mobile device 60 is adapted to implement the electronic catalog system as hardware, software or as a combination of hardware and software. In one embodiment, implemented as a software task, the program code operative to implement the electronic catalog system is executed as one or more tasks running on processor 62 and either (1) stored in one or more memories 64, 66, 68 or (2) stored in local memory within the processor 62 itself.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. As numerous modifications and changes will readily occur to those skilled in the art, it is intended that the invention not be limited to the limited number of embodiments described herein. Accordingly, it will be appreciated that all suitable variations, modifications and equivalents may be resorted to, falling within the spirit and scope of the present invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A radio frequency (RF) switch, comprising:
a first transistor operative to couple a transmit signal from a transmitter to a first antenna;
a second transistor operative to couple said transmit signal from a transmitter to a second antenna;
a third transistor operative to couple a receive signal from said first antenna to a receiver;
a fourth transistor operative to couple said receive signal from said second antenna to said receiver; and
a control circuit coupled to said first transistor, said second transistor, said third transistor and said fourth transistor, said control circuit operative to place only one of said four transistors in an on state while placing the remaining three transistors in a reverse biased off state.

2. The switch according to claim 1, wherein said first transistor, said second transistor, said third transistor and said fourth transistor comprise N channel Metal Oxide Semiconductor (NMOS) transistors.

3. The switch according to claim 1, further comprising a low pass filter (LPF) disposed between said control circuit and each of said first transistor, said second transistor, said third transistor and said fourth transistor, each LPF operative to suppress RF leakage from a drain, gate and source of each transistor to said logic control circuit thereby reducing RF signal loss.

4. The switch according to claim 1, wherein said four transistors are configured as a double pole, double throw switch.

5. A radio frequency (RF) switch, comprising:
a first transistor having a source, drain and gate, said first transistor operative to couple a transmit signal from a transmitter to a first antenna;
a second transistor having a source, drain and gate, said second transistor operative to couple said transmit signal from a transmitter to a second antenna;
a third transistor having a source, drain and gate, said third transistor operative to couple a receive signal from said first antenna to a receiver;
a fourth transistor having a source, drain and gate, said fourth transistor operative to couple said receive signal from said second antenna to said receiver;
a control circuit coupled to the source, drain and gate terminals of said first transistor, said second transistor, said third transistor and said fourth transistor, said control circuit operative to generate source, drain and gate signals such that only one of said four transistors is in an on state while placing the remaining three transistors in a reverse bias off state.

6. The switch according to claim 5, wherein said first transistor, said second transistor, said third transistor and said fourth transistor comprise N channel Metal Oxide Semiconductor (NMOS) transistors.

7. The switch according to claim 5, further comprising a low pass filter (LPF) disposed between said control circuit and the source, drain and gate of each of said first transistor, said second transistor, said third transistor and said fourth transistor, each LPF operative to suppress RF leakage from said drain, gate and source of each transistor to said logic control circuit thereby reducing RF signal loss.

8. The switch according to claim 7, wherein said LPF comprises an RC network.

9. The switch according to claim 5, wherein one of said four transistors is placed in said on state by applying a high voltage applied to its gate while its source and drain are both coupled to ground.

10. The switch according to claim 5, wherein said remaining transistors are placed in said reverse biased off state by applying a high voltage to their drain and source while their gate is coupled to ground.

11. The switch according to claim 5, wherein said four transistors are configured as a double pole, double throw switch.

12. The switch according to claim 5, further comprising dc blocking capacitors coupled to the drain and source of each said transistor, said dc blocking capacitors operative to allow the biasing of each transistor independently of the respective three neighboring transistors.

13. The switch according to claim 5, further comprising package bond wires connecting transmitter, receiver, first antenna and second antenna internal die pads to external switch package pins, said bin wires operative to form a matching network when combined with external shunt capacitors connected thereto.

14. A method for use with a radio frequency switch, said method comprising:
providing a first transistor having a source, drain and gate, said first transistor operative to couple a transmit signal from a transmitter to a first antenna;
providing a second transistor having a source, drain and gate, said second transistor operative to couple said transmit signal from a transmitter to a second antenna;
providing a third transistor having a source, drain and gate, said third transistor operative to couple a receive signal from said first antenna to a receiver;
providing a fourth transistor having a source, drain and gate, said fourth transistor operative to couple said receive signal from said second antenna to said receiver;
generating source, drain and gate signals for said first transistor, said second transistor, said third transistor and said fourth transistor, such that only one of said four transistors is in an on state while the remaining three transistors are in a reverse bias off state;
wherein a transistor is placed in an on state by forward biasing its gate-source junction; and
wherein a transistor is placed in an off state by reverse biasing its gate-source junction.

15. The method according to claim 14, wherein said first transistor, said second transistor, said third transistor and said fourth transistor comprise N channel Metal Oxide Semiconductor (NMOS) transistors.

16. The method according to claim 14, further comprising providing a low pass filter (LPF) disposed between said control circuit and the source, drain and gate of each of said first transistor, said second transistor, said third transistor and said fourth transistor.

17. A wireless communication device, comprising:
a first antenna;
a second antenna;
a transmitter;
a receiver;
an RF switch; said RF switch comprising:
a first transistor operative to couple a transmit signal from said transmitter to said first antenna;
a second transistor operative to couple said transmit signal from a transmitter to said second antenna;
a third transistor operative to couple a receive signal from said first antenna to said receiver;
a fourth transistor operative to couple said receive signal from said second antenna to said receiver; and
a control circuit coupled to said first transistor, said second transistor, said third transistor and said fourth transistor, said control circuit operative to place only one of said four transistors in an on state while placing the remaining three transistors in a reverse biased off state.

18. The device according to claim 17, wherein said first transistor, said second transistor, said third transistor and said fourth transistor comprise N channel Metal Oxide Semiconductor (NMOS) transistors.

19. The device according to claim 17, further comprising a low pass filter (LPF) disposed between said control circuit and each of said first transistor, said second transistor, said third transistor and said fourth transistor, each LPF operative to suppress RF leakage from a drain, gate and source of each transistor to said logic control circuit thereby reducing RF signal loss.

20. The device according to claim 17, wherein said LPF comprises an RC network.

21. The device according to claim 15, wherein said four transistors are configured as a double pole, double throw switch.
